(19) United States
(12) Patent Application Publication
(10) Pub. No.: US 2025/0037264 A1
(43) Pub. Date: Jan. 30, 2025

(54) Lug Defect Detection Method and System

(71) Applicants: REPT BATTERO Energy Co., Ltd., Wenzhou (CN); Shanghai Ruipu Energy Co., Ltd., Shanghai (CN)

(72) Inventors: Hui CAO, Wenzhou (CN); Shiming WU, Wenzhou (CN); Wei NI, Wenzhou (CN); Linsheng CAI, Wenzhou (CN); Hui WANG, Wenzhou (CN); Shaoke ZHANG, Wenzhou (CN)

(21) Appl. No.: 18/744,157

(22) Filed: Jun. 14, 2024

(30) Foreign Application Priority Data
Jul. 28, 2023 (CN) 202310943692.2

(51) Int. Cl. G06T 7/00; G06T 5/70; G06T 7/62; G06T 7/73; H01M 10/42; H01M 10/48

(52) U.S. Cl. CPC G06T 7/0006; G06T 5/70; G06T 7/62; G06T 7/73; H01M 10/4285; H01M 10/48; G06T 2207/10024; G06T 2207/30108

(57) ABSTRACT

The present disclosure provides a lug defect detection method and system. The detection method includes during a preparation process of a battery cell, collecting original image of a relevant area of lug; in a digitally processed original image, setting a baseline based on an edge position of the pole piece body, and from the baseline, setting a side close to the pole piece body as a first detection area, setting another side away from the pole piece body as a second detection area; and detecting a target lug image in the first detection region and the second detection region according to a preset sequence, and determining whether a currently detected cell is a defective cell.

### CROSS-REFERENCE TO RELATED APPLICATION

This application claims priority to Chinese Patent Application No. 202310943692.2 filed Jul. 28, 2024, the disclosure of which is incorporated herein by reference in its entirety and for all purposes.

### TECHNICAL FIELD

The present disclosure mainly relates to the technical fields of cell lug detection field, and in particular to a lug defect detection method and system.

### BACKGROUND

Cell lugs serve as the terminal interface for the cell to connect to the outside, and their quality directly affects the safety and ultimate life of a finished cell. During the cell manufacturing process, such as the lamination or winding process, the positive electrode piece, the negative electrode piece and the diaphragm are composed of the cell through relevant processes, and in this process, it is necessary to determine whether the lugs of the positive electrode piece and the negative electrode piece are missing or folded.

No matter it is the lamination process or the winding process, the overlap, flatness and absence of folds or missing lugs of the positive and negative electrodes are important manifestations of quality standards. At present, the quality detection of cell lugs is mainly measured through industrial vision combined with correction devices, optical fiber sensing positioning, etc., but the detection results are not good. In actual production, quality problems such as overall folding, partial folding, and missing lugs often occur, and in practical disclosures, especially the folding lugs will cause a risk of short circuit between the positive and negative electrodes, leaving potential safety hazards for cell use.

### SUMMARY

The technical problem to be solved by the present disclosure is to provide a lug defect detection method and system, which can quickly and accurately detect defective lug during the cell preparation process and improve cell quality.

In order to solve the above technical problems, the present disclosure provides a lug defect detection method, comprising: during a preparation process of a battery cell, collecting original image of a relevant area of lug, wherein, the battery cell includes a pole piece, and the pole piece includes a pole piece body and a lug; in a digitally processed original image, setting a baseline based on an edge position of the pole piece body, and from the baseline, setting a side close to the pole piece body as a first detection area, setting another side away from the pole piece body as a second detection area; and detecting a target lug image in the first detection region and the second detection region according to a preset sequence, and determining whether a currently detected cell is a defective cell.

In one embodiment of the present disclosure, during a preparation process of a battery cell, step of collecting original image of a relevant area of lug further comprises: during a process of continuous preparation of multiple battery cells, continuously collecting original image of a relevant area of lug corresponding to each battery cell before the pole piece corresponding to each battery cell is rolled or stacked.

In one embodiment of the present disclosure, the lug defect detection method further comprises using two sets of machine vision inspection devices to respectively perform the step of collecting original image, setting the baseline and determining whether the currently detected cell is the defective cell, the two sets of machine vision inspection devices are respectively arranged in a first detection position and a second detection position during the preparation process of the battery cell, and the detection method further includes: when both sets of machine vision inspection devices determine that the currently detected cell is a defective cell, marking the currently detected cell as a defective cell; and when only one set of machine vision inspection devices determines the currently detected cell is a defective cell, marking the currently detected cell as a suspected defective cell for re-inspection.

In one embodiment of the present disclosure, the preset sequence includes sequentially detecting the first detection region and the second detection area, wherein if part or all of the target lug image is detected in the first detection area, judging the currently detected cell as a defective cell, otherwise, determining whether the currently detected cell is a defective cell according to one of or a combination of one or more of outline, length and width dimensions or area of the target lug image in the second detection area.

In one embodiment of the present disclosure, if part or all of the target lug image is not detected in the first detection area, the detection method further includes using a regional consistency algorithm to obtain multiple area points in the second detection area, connecting multiple area points to form a closed area, thereby obtaining the target lug image, wherein, the regional consistency algorithm includes: constructing a square matrix [n] with nth order all being 1, and obtain a same area pixel a_{[n]} in the second detection area, wherein, the same area pixel a_{[n]} is obtained by binary separation of a final grayscale image obtained by denoising process and grayscale process in the second detection area; comparing the same area pixel a_{[n]} with the square matrix [n], and if a result shows consistency, assigning a position where the same area pixel a_{[n]} is located to a value of 255 and setting as an area point; and connecting all area points in the second detection area to form the closed region A, and obtaining the outline, length and width dimensions or area of the target lug image a′_{[n]} according to the closed region A, thereby determining whether the currently detected cell is a defective cell.

In one embodiment of the present disclosure, the lug defect detection method further comprises using following method to compare a similarity SIM(i,j) between the region A and a preset lug image, thereby determining whether the currently detected cell is defective cell according to an outline of the target lug image in the second detection area:

$$SIM ( i , j ) = \frac{u * \sum A ( i , j ) Y ( i , j )}{\sqrt{\sum {( A ( i , j ) )}^{2}} \sqrt{\sum {( Y ( i , j ) )}^{2}}}$$

wherein, A(i,j) is an outer edge of the region A, Y(i,j) is an outer edge of the preset lug image, and u is an adjustable scaling coefficient.

In one embodiment of the present disclosure, the lug defect detection method further comprises using following manner to calculate a lug transverse width L and a lug longitudinal width H, thereby determining whether the currently detected cell is defective cell according to the length and width dimensions of the target lug image in the second detection area:

$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix}$$

wherein, a′_{[n]}_{_{tw}} is a lateral position value of pixel a′_{[n]} in column w and row i, a′_{[n]}_{ᵢᵥ} is a horizontal position value of pixel a′_{[n]} in column v and row i, a′_{[n]}_{ₚⱼ} is a vertical position value of pixel a′_{[n]} in column j and row p, a′_{[n]}, is a vertical position value of pixel a′_{[n]} in column j and row q, and the w, v, p and q are obtained according to the region A, N represents a number of rows of a′_{[n]}, and M represents a number of columns of a′_{[n]}.

In one embodiment of the present disclosure, the lug defect detection method further comprises using following manner to calculate a lug transverse width L and a lug longitudinal width H, then calculating an area S_{A} of the region A, then determining whether the currently detected cell is defective cell according to an area of the target lug image in the second detection area:

$${s}_{A} = \frac{{\int }_{{L}_{w}}^{{L}_{v}} f ( {a}_{[ n ]}^{′} ) dL + {\int }_{{H}_{p}}^{{H}_{q}} g ( {a}_{[ n ]}^{′} ) dH}{2}$$

wherein, L_{w} is a left starting point of the lug transverse width L, Lᵥ is a right end point of the lug transverse width L, Hₚ is a lower starting point of the lug longitudinal width H, H_{q} is an upper end point of the lug longitudinal width H, f(a′_{[n]}) is a function value of the transverse synthesis of the lug, g(a′_{[n]}) is a function value of the longitudinal synthesis of the lug.

In one embodiment of the present disclosure, the digitally processed original image is a final grayscale image Gray(i,j) obtained by sequentially performing the denoising process and the grayscale process on the original image, and the method further includes setting the baseline in the final grayscale image Gray(i,j) according to an edge position of the pole piece body of the battery cell.

In one embodiment of the present disclosure, if part or all of the target lug image is not detected in the first detection area, the detection method further includes performing a binary separation of pixel on the final grayscale image Gray(i,j) according to following formula:

$$B ( i , j ) = \{ \begin{matrix}0 & Gray ( i , j ) <= h \\ 1 & Gray ( i , j ) > h\end{matrix}$$

wherein, a value range of h is 125˜255.

In one embodiment of the present disclosure, the denoising process comprises realizing stacking of three primary colors in the following manner to obtain the denoised image corresponding to the original image.

$$\{ \begin{matrix}R ( i , j ) = {\sum }_{m , n} R ( i + m , j + n ) * {K}_{R} ( m , n ) \\ G ( i , j ) = {\sum }_{m , n} G ( i + m , j + n ) * {K}_{G} ( m , n ) \\ B ( i , j ) = {\sum }_{m , n} B ( i + m , j + n ) * {K}_{B} ( m , n )\end{matrix}$$

wherein, (i,j) is a two-dimensional matrix position of any pixel in the original image, R(i,j), G(i,j) and B(i,j) are corresponding values of the three primary colors RGB, K_{R}(m,n), K_{G}(m,n) and K_{B}(m,n) are filter algorithms corresponding to the three primary colors RGB.

In one embodiment of the present disclosure, the grayscale process comprises processing the denoised image in following manner to obtain the final grayscale image Gray(i,j):

$$Gray ( i , j ) = {k}_{1} R ( i , j ) + {k}_{2} G ( i , j ) + {k}_{3} B ( i , j )$$

wherein, k₁, k₂ and k₃ are corresponding weighted values of the three primary colors RGB.

Another aspect of the present disclosure also provides a lug defect detection system, comprising at least one set of machine vision inspection device, the machine vision inspection device includes a camera and a processor, wherein, the camera is adapted to collect original image of relevant area of lug during a preparation process of a battery cell, wherein the battery cell includes a pole piece, and the pole piece includes a pole piece body and a lug; the processor is adapted to digitally process the original image and set a baseline according to an edge position of the pole piece body of the battery cell, wherein, from the baseline, a side close to the pole piece body in the battery cell is a first detection area, and another side away from the pole piece body is a second detection area; and the processor is also adapted to detect a target lug image in the first detection area and the second detection area in a preset sequence according to the above mentioned detection method and determine whether the currently detected cell is a defective cell.

In one embodiment of the present disclosure, number of the machine vision inspection devices is two groups, comprising a first group of machine vision inspection devices located at a first detection position and a second group of machine vision inspection devices located at a second detection position, the first detection position and the second detection positions are respectively located at process positions before the pole piece is rolled or stacked during the preparation process of the battery cell, and the first detection position is located in a former production sequence compared to the second detection position, wherein, when both the first group of machine vision inspection devices and the second group of machine vision inspection devices determine that the currently detected cell is a defective cell, the first group of machine vision inspection device and/or the second group of machine vision inspection device is configured to mark the currently detected cell as a defective cell; and when only the first group of machine vision inspection device or only the second group of machine vision inspection device determines that the currently detected cell is a defective cell, the first group of machine vision inspection device or the second group of machine vision inspection device is configured to mark the currently detected cell as a suspected defective cells for re-inspection.

Compared with the existing technology, this disclosure has the following advantages: through the lug defect detection method and system, the invisible quality problems of lugs in the cell lamination process or winding process can be solved more quickly and accurately, eliminating the hidden danger of single cell short circuit. This disclosure applies industrial vision combined with cell displacement to quickly detect the quality status of lugs in the area in real time, and through the arrangement of dual vision, redundant functions are added to completely eliminate defective lug cells, significantly improving cell quality.

### BRIEF DESCRIPTION OF THE DRAWINGS

The drawings are included to provide a further understanding of the present disclosure, and they are included and constitute a part of the present disclosure, the drawings show the embodiments of the present disclosure, serving to explain the principles of the present disclosure together with the description. In the drawings:

FIG. 1a is a schematic flow chart of a lug defect detection method according to an embodiment of the present disclosure;

FIG. 1b is a schematic flow chart of a lug defect detection method according to another embodiment of the present disclosure;

FIG. 2 is a schematic view of different forms of lugs detected using a lug defect detection method according to an embodiment of the present disclosure;

FIG. 3 is a schematic structural view of a lug defect detection system according to an embodiment of the present disclosure;

FIG. 4 is a schematic view of the detection area in lug defect detection method according to an embodiment of the present disclosure;

FIG. 5 is a schematic flow chart of lug defect detection method according to another embodiment of the present disclosure;

FIG. 6 is a schematic view of the principle of the regional consistency algorithm in a lug defect detection method according to an embodiment of the present disclosure; and

FIG. 7 is a flow chart of a lug defect detection method according to another embodiment of the present disclosure.

### PREFERRED EMBODIMENT OF THE PRESENT DISCLOSURE

In order to illustrate the technical solutions in the embodiments of the present disclosure more clearly, the drawings that need to be used in the description of the embodiments will be briefly introduced below. Obviously, the drawings in the following description are only some embodiments of the present disclosure, and for those skilled in the art, other drawings can also be obtained based on these drawings without creative effort.

As indicated in this disclosure and claims, the terms “a”, “an”, “a kind of” and/or “the” do not specifically refer to the singular and may include the plural unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The relative arrangements of components and steps, numerical expressions and numerical values set forth in these embodiments do not limit the scope of the present disclosure unless specifically stated otherwise. At the same time, it should be understood that, for the convenience of description, the sizes of the various parts shown in the drawings are not drawn according to the actual proportional relationship. Techniques, methods and devices known to those of ordinary skill in the relevant art may not be discussed in detail, but where appropriate, such techniques, methods and devices should be considered part of the authorized specification. In all embodiments shown and discussed herein, any specific values should be construed as illustrative only, and not as limiting. Therefore, other examples of the exemplary embodiment may have different values. It should be noted that like numerals and letters denote like items in the following figures, therefore, once an item is defined in one figure, it does not require further discussion in subsequent drawings.

In the description of the present disclosure, it should be understood that orientation words such as “front, back, up, down, left, right”, “landscape, portrait, vertical, horizontal” and “top, bottom” etc. indicating the orientation or positional relationship is generally based on the orientation or positional relationship shown in the drawings, only for the convenience of describing the disclosure and simplifying the description, in the absence of a contrary statement, these orientation words do not indicate or imply that the device or element referred to must have a specific orientation or be constructed and operated in a specific orientation, and therefore cannot be construed as limiting the scope of protection of this disclosure; the orientation words “inside and outside” refer to inside and outside relative to the outline of each part itself.

For the convenience of description, spatially relative terms may be used here, such as “on . . . ”, “over . . . ”, “on the upper surface of . . . ”, “above”, etc., to describe the spatial positional relationship between one device or feature and other devices or features. It will be understood that, in addition to the orientation depicted in the drawings, the spatially relative terms are intended to encompass different orientations of the device in use or operation. For example, if the device in the drawings is turned over, devices described as “on other devices or configurations” or “above other devices or configurations” would then be oriented “beneath other devices or configurations” or “under other devices or configurations”. Thus, the exemplary term “above” can encompass both an orientation of “above” and “beneath”. The device may be otherwise oriented (rotated 90 degrees or at other orientations) and making a corresponding explanation for the space relative description used here.

In addition, it should be noted that the use of words such as “first” and “second” to define components is only for the convenience of distinguishing corresponding components, unless otherwise stated, the above words have no special meanings, and therefore cannot be construed as limiting the protection scope of the present disclosure. In addition, although the terms used in this disclosure are selected from well-known and commonly used terms, some terms mentioned in the specification of this disclosure may be selected by the applicant according to his or her judgment, and their detailed meanings are listed in this article described in the relevant segment of the description. Furthermore, it is required that this disclosure be understood not only by the actual terms used, but also by the meaning implied by each term.

The existing battery cell lug quality inspection methods mainly focus on: 1. Using industrial vision combined with a correction device to correct the overlap of the lugs, so that the positive and negative lugs of the battery cell overlap within the unified nominal value; 2. Using sensors such as optical fibers to detect the presence and wrinkles of the lugs at specific points; 3. Using industrial vision to detect the distance between the lugs to determine the quality of the corresponding lugs. However, these methods still have major shortcomings in actual production disclosures. For example, the detection accuracy of defective lugs is not high, the detection speed is slow, and it is easy to misjudge.

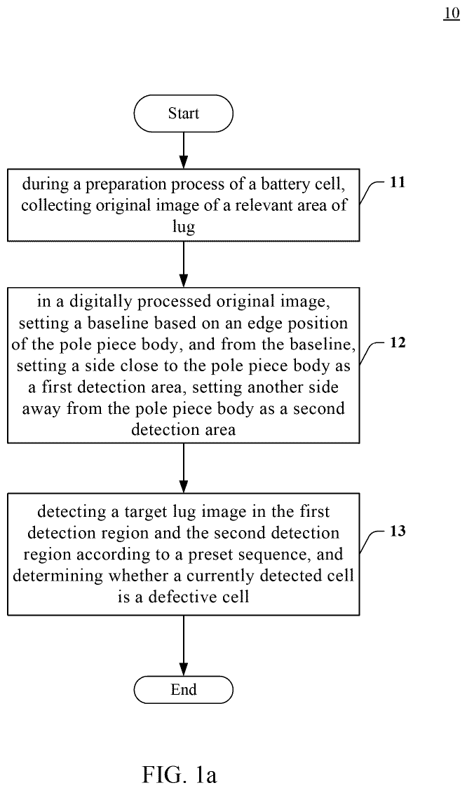

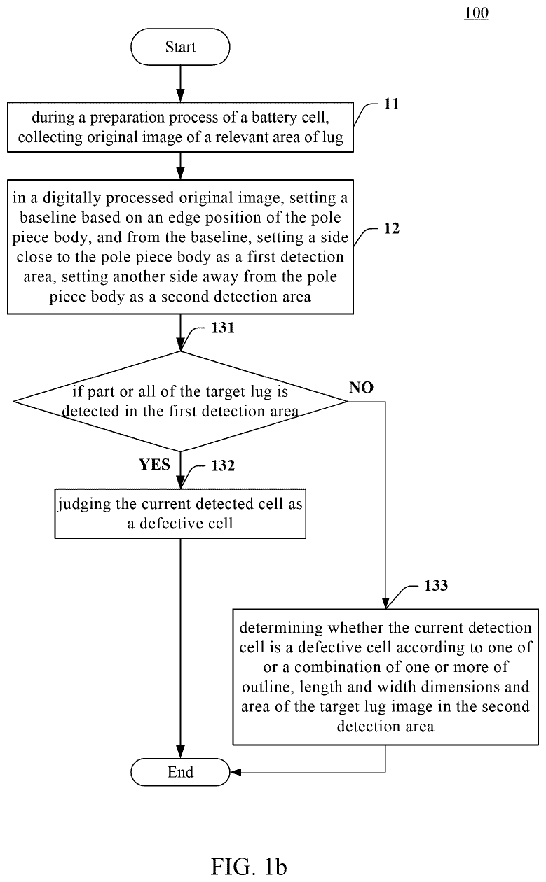

In order to solve the above technical problems, this disclosure proposes a lug defect detection method 10 (hereinafter referred to as “detection method 10”) with reference to FIG. 1a, which can quickly and accurately detect defective lugs during the cell preparation process and improve cell quality. Many figures in this disclosure including FIG. 1a, use some flow charts to illustrate the operations performed by the system according to the embodiments of the disclosure. It should be understood that the preceding or following operations are not necessarily performed in exact order. Instead, the various steps can be processed in reverse order or simultaneously. At the same time, other operations may be added to these processes, or one step or steps may be removed from these processes.

According to FIG. 1a, the detection method 10 includes steps 11 to 13. Step 11 is during a preparation process of a battery cell, collecting original image of a relevant area of lug. The cell includes a pole piece, and the pole piece includes a pole piece body and a lug. Step 12 is in a digitally processed original image, setting a baseline based on an edge position of the pole piece body, and from the baseline, setting a side close to the pole piece body as a first detection area, setting another side away from the pole piece body as a second detection area. Step 13 is detecting a target lug image in the first detection region and the second detection region according to a preset sequence, and determining whether a currently detected cell is a defective cell. It should be noted that in different embodiments of the present disclosure, the pole piece includes a pole piece body and a lug, and this is a theoretical definition and division made to facilitate the description of the technical features of the present disclosure; in practical disclosures, the pole piece body and the lug according to the definition of this disclosure can be integrated, and this disclosure does not limit this.

For example, during the detection process, the first detection area and the second detection area can be detected simultaneously, or the first detection area and the second detection area can be detected sequentially, and the detection order can be selected according to the actual situation. Preferably, the preset sequence includes sequentially detecting the first detection area and the second detection area, wherein if part or all of the target lug image is detected in the first detection area, the current detection cell is determined to be a defective cell, otherwise, judging whether the current detection cell is a defective cell according to one or more combinations of the outline, length and width dimensions or area of the target lug image a′_{[n]} in the second detection area.

FIG. 1b shows a lug defect detection method 100 of the present disclosure (hereinafter referred to as the “detection method 100”) implemented according to the above preferred manner. According to the detection method 100, steps 11 and 12 are the same as the detection method 10, which are the steps of collecting the original image and setting the baseline, the first detection area and the second detection area. The difference is that the detection method 100 shown in FIG. 1b additionally has steps 131-133. Specifically, step 131 is to determine if part or all of the target lug image is detected in the first detection area, and if the detection result is yes, step 132 is executed to judge that the currently detected cell is a defective cell. If the detection result of step 131 is no, step 133 is executed, determining whether the currently detected cell is a defective cell according to one or more combinations of the outline, length and width dimensions or area of the target lug image a′_{[n]} in the second detection area.

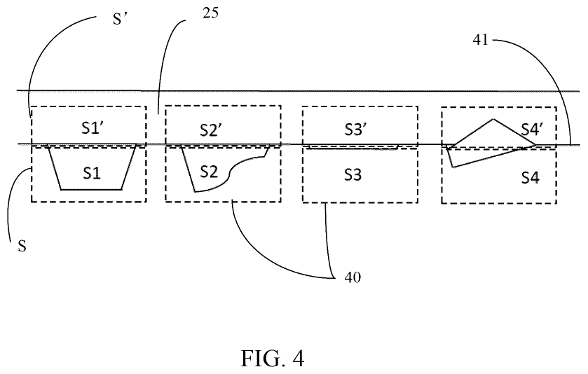

For example, the original image of the relevant area of lug can be understood as an original image of the lug and its surrounding area with a unified shape (how to delineate the relevant area will be further explained below with reference to FIG. 4). In a preferred embodiment of the present disclosure, the above-mentioned detection method 10 is applied during the process of continuous preparation of cells, that is, during the process of continuous preparation of multiple battery cells, continuously collecting original image of a relevant area of lug corresponding to each battery cell before the positive electrode piece, negative electrode piece and diaphragm corresponding to each battery cell is rolled or stacked.

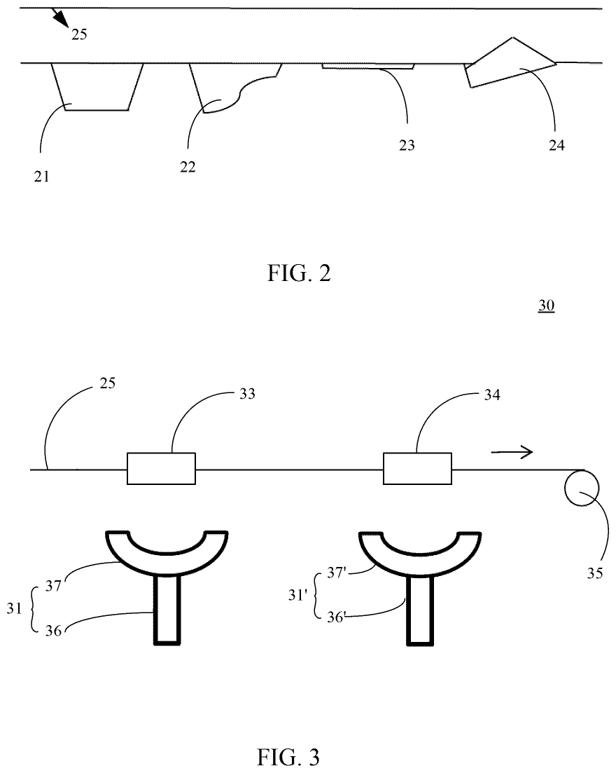

Continuing to refer to FIG. 2, FIG. 2 shows a schematic view of different forms of lugs, and the lug in the normal state is shown as reference numeral 21; the state of the defective lug is shown as reference numeral 22; the state of the missing lug is as shown as reference numeral 23; the folded state of the lug is shown as reference numeral 24; reference numeral 25 refers to the pole piece body. This embodiment only shows the lugs in four states, but the states of the lugs detected in this disclosure are not limited to this. One of the purposes of this disclosure is to implement the lug defect detection method through one or more sets of machine vision detection devices, thereby improving cell quality in the embodiment shown in FIG. 1a and FIG. 1b.

In order to better explain the detection method 10 and its preferred modifications, a lug defect detection system 30 (hereinafter referred to as “detection system 30”) is now introduced with reference to FIG. 3. Referring to FIG. 3, the detection system 30 includes two groups of machine vision detection devices, namely a first group of machine vision detection device 31 and a second group of machine vision detection device 31′, wherein, the first group of machine vision detection device 31 and the second group of machine vision detection device 31′ respectively include a first camera 36, a second camera 36′ and respective processors (not shown). It should be noted that the detection system 30 can apply the detection method 10 or the detection method 100. Therefore, in the following description of the present disclosure, some detailed features of the detection system 30 may be referred to the descriptions of the detection method 10 and the detection method 100, and repeated content will not be described again.

Specifically, the first camera 36 and the second camera 36′ are suitable for collecting original images of the relevant areas of lugs during the preparation process of the cells. Referring to FIG. 3, in a specific implementation of this embodiment, the first group of machine vision detection device 31 and the second group of machine vision detection device 31′ also have a first brightness adjuster 37 and a second brightness adjuster 37′ respectively, the first brightness adjuster 37 and the second brightness adjuster 37′ are shown as semi-circular rings in FIG. 3, and the first camera 36 and the second camera 36′ are shown as rectangular parts in FIG. 3, the first camera 36 and the second camera 36′ are respectively installed on the first brightness adjuster 37 and the second brightness adjuster 37′. The first camera 36 and the second camera 36′ are interconnected with their corresponding processors and can perform data transmission. The first group of machine vision detection device 31 and the second group of machine vision detection device 31′ are respectively arranged at the first detection position and the second detection position during the preparation process of the cell. The driving mechanism 35 drives the pole pieces to rotate at high speed, and the first lug 33 and the second lug 34 continuously arranged on the pole pieces will pass through two sets of machine vision detection devices in sequence. The first group of machine vision detection device 31 and the second group of machine vision detection device 31′ will sequentially collect the original images on each passing relevant area of lug, and the processors in the two groups of machine vision detection devices are suitable for using the same algorithm to collect original images being processed to obtain corresponding digitally processed original images. It can be understood that in practical disclosures, some parameters of the algorithm can be adjusted according to the conditions of the production site, so as to achieve better coordination and cooperation between the two sets of machine vision detection devices. When adjusting the parameters, the operating speed of the pole pieces, the distance between the two sets of machine vision detection devices and the currently prepared cell model etc. can be considered, and this disclosure does not limit this.

In this disclosure, the processor of the machine vision detection device is usually configured to detect target lug images in the first detection area and the second detection area in a preset sequence, and then determine whether the currently detected cell is a defective cell. In some preferred embodiments, the processor can also sequentially detect the detection target lug images of the first detection area and the second detection area in a preset sequence, wherein if part or all of the target lugs are detected in the first detection area, judging the current detected cell as a defective cell, otherwise, determining whether the current detection cell is a defective cell according to one or more arbitrary combinations of the outline, length and width dimensions and area of the target lug image a′_{[n]} in the second detection area.

Preferably, this embodiment uses two sets of machine vision detection devices to detect lug defects, and the purpose of using two sets of machine vision detection device is to ensure the reliability of the detection; only when the cell detected by both sets of machine vision detection devices are diagnosed as normal, will they be considered qualified. If the cell is diagnosed as abnormal by both groups, it will be directly rejected as a defective cell. In other cases, it will be judged as a suspected defective cell being transferred to the manual visual detection area for manual judgment. Of course, based on the embodiment shown in FIG. 3, more sets of machine vision detection devices can be used to detect lug defects according to actual conditions, and the present disclosure is not limited to this. In addition, when two sets of machine vision detection devices detect target lug images in the first detection area and the second detection area in a preset sequence and determine whether the currently detected cell is a defective cell, the same detection order can be adopted, or different detection orders can be adopted. When the two sets of machine vision detection devices determine whether the currently detected cell is a defective cell according to one or more combinations of the outline, length and width dimensions or area of the target lug image a′_{[n]} in the second detection area, the judgment methods used can be the same or different. For example, the first group of machine vision detection device 31 determines whether the current detection cell is a defective cell based on the outline and length and width dimensions of the target lug image in the second detection area, while the second group of machine vision detection device 31′ determines whether the current detection cell is a defective cell based on the outline, length and width dimensions and area of the target lug image a′_{[n]} in the second detection area. Details of different situations will not be listed one by one here. Preferably, the first group of machine vision detection device 31 and the second group of machine vision detection device 31′ adopt the same detection sequence and the same judgment method.

In this embodiment, the cameras in the first group of machine vision detection device 31 and the second group of machine vision detection device 31′ shown in FIG. 3 can perform original image collection with reference to step 11 in the detection method 10 shown in FIG. 1a, and the processors therein is adapted to perform image processing with reference to steps 12 and 13 in the detection method 10 as shown in FIG. 1a. For example, a baseline is set based on the data information contained in the original image and based on the edge position of the pole piece body 25 of the cell, wherein the side of the baseline close to the pole piece body 25 is the first detection area, and the other side further away from the pole piece body 25 is the second detection area. The processor is further configured to detect the target lug image in the first detection area and/or the second detection area according to a built-in algorithm and determine whether the current detection cell is a defective cell. The algorithm part will be further explained below.

Exemplarily, FIG. 4 shows a schematic view of the principle of delineating a baseline to obtain the first detection area S′ and the second detection area S in this embodiment. Referring to FIG. 4, FIG. 4 shows a schematic view of a set of continuous lug defect detection areas during the continuous preparation process of multiple battery cells, including four first detection areas, namely No. 1 first detection area S1′, No. 2 first detection area S2′, No. 3 first detection area S3′, No. 4 first detection area S4′, and four second detection areas, namely No. 1 second detection area S1, No. 2 second detection area S2, No. 3 second detection area S3, No. 4 second detection area S4. In this embodiment, when battery cells of the same model are continuously prepared, the relevant area of lug proposed above is a rectangular area 40 with a uniform size. After obtaining the original image of the rectangular area 40 corresponding to each lug, after digital processing, the baseline 41 can be marked in the rectangular area 40 according to the edge position of the pole piece body 25. For example, in this embodiment, the baseline 41 itself is the edge position of the pole piece body 25. After setting the baseline 41, it can further set the side close to the pole piece body 25 (or in this embodiment, it can be understood as the area above the baseline 41 in the rectangular area 40) as the first detection area S′, and the other side further away from the pole piece body 25 is the second detection area S.

The basic concepts of a lug defect detection method and system proposed by this disclosure have been preliminarily explained above with reference to FIG. 1a to 4, and the following will further describe in detail on how to perform data processing on the original images of the collected relevant areas of lug in some preferred embodiments based on the detection method 10 in FIG. 1a, the detection method 100 in FIG. 1b, and the detection system 30 in FIG. 3.

First, in some embodiments of the present disclosure, the original image that has been digitized is the final grayscale image Gray(i,j) obtained by sequentially performing denoising processing and grayscale processing on the original image.

Preferably, the denoising process includes stacking three primary colors in the following manner to obtain a denoised image corresponding to the original image:

$$\{ \begin{matrix}R ( i , j ) = {\sum }_{m , n} R ( i + m , j + n ) * {K}_{R} ( m , n ) \\ G ( i , j ) = {\sum }_{m , n} G ( i + m , j + n ) * {K}_{G} ( m , n ) \\ B ( i , j ) = {\sum }_{m , n} B ( i + m , j + n ) * {K}_{B} ( m , n )\end{matrix}$$

wherein, (i,j) is the two-dimensional matrix position of any pixel in the original image, R(i,j), G(i,j) and B(i,j) are the corresponding values of the three primary colors RGB, the value range is [0,250] or [0,255], etc., and the upper limit value can be selected between 250-255; K_{R}(m,n), K_{G}(m,n) and K_{B}(m,n) are filter algorithms corresponding to the three primary colors RGB, and the filters can be adjusted according to actual disclosure conditions and can be matched filters or high-pass filters, low-pass filters and band-pass filters to adjust the algorithm.

For example, the stacking of the three primary colors includes calculating the R value of each pixel in the original image, the R value has a corresponding filter K_{R}(m,n). The main function of the filter is to remove impurities in the original image. The R value R(i,j) of the original image is the sum of the R values of each pixel of the original image after filtering. The method of calculating the G value and B value is similar, which will not be repeated into details here. This disclosure realizes the stacking of three primary colors through algorithms, and finally presents the denoised image corresponding to the original image.

Further preferably, the grayscale processing includes processing the denoised image in the following manner to obtain the final grayscale image Gray(i,j):

$$Gray ( i , j ) = {k}_{1} R ( i , j ) + {k}_{2} G ( i , j ) + {k}_{3} B ( i , j )$$

wherein, k₁, k₂ and k₃ values are the weighted values corresponding to the three primary colors RGB and can be set according to the specific usage conditions.

The original image is denoised and grayscale processed to obtain a final grayscale image, and referring to FIG. 4, a baseline 41 is set in the final grayscale image based on the edge position of the pole piece body 25 in the cell. The baseline 41 divides the detection area into two areas: a first detection area S′ and a second detection area S, wherein the first detection area S′ is a lug-prohibited area, also known as a lug-free area; the second detection area S is the lug-complete area, also known as the lug area. In both the first detection area S′ and the second detection area S detection area, the width, shape and area of the figure included in the edge line of the lug can be measured to determine the quality of the lug. Preferably, in some embodiments of the present disclosure including FIG. 1a and FIG. 1b, only when part or all of the target lug image is not detected in the first detection area S′, will the the outline, length and width dimensions or area of the target lug image a′_{[n]} are calculated in second detection area S′ according to the corresponding algorithm. So that it can further verify whether normal lugs that meet the requirements and standards appear in the second detection area S, that is, the lug area. In this way, the amount of calculation can be reduced, and the calculation and response speed of the machine vision detection device can be improved.

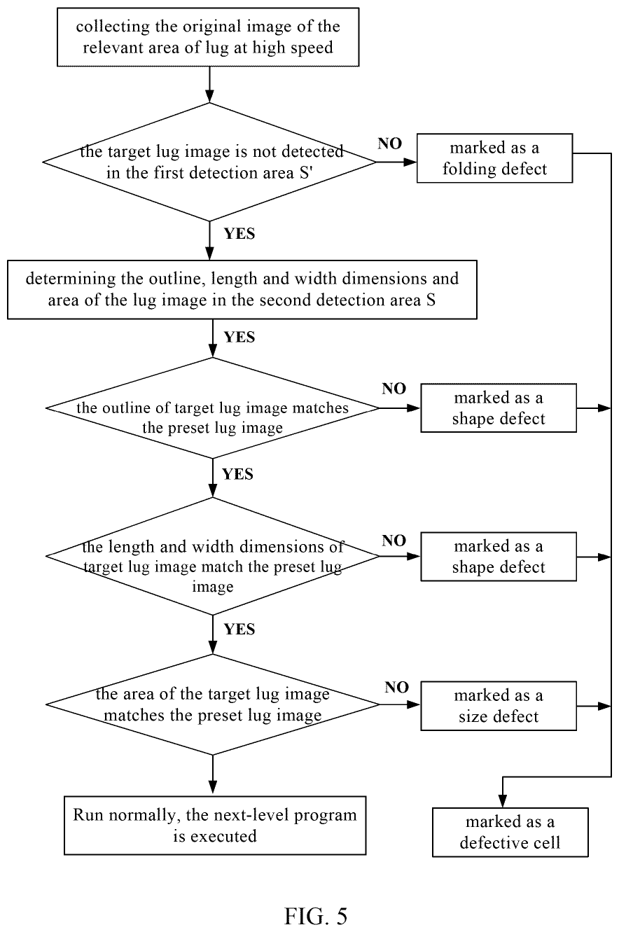

Continuing to refer to FIG. 5, FIG. 5 further optimizes the detection method 10 shown in FIG. 1a and the detection method 100 shown in FIG. 1b, especially for detailed layout of the algorithm of the target lug image in the second detection area S. First, after collecting the original image of the relevant area of lug at high speed, it first detects whether the target lug image is detected in the first detection area S′, and if the target lug image is detected, the lug is directly marked as a folding defect. If the target lug image is not detected, the second detection area S is further detected. Detecting the second detection area S includes sequentially determining whether the outline, length and width dimensions and area of the lug image of the second detection area S match the preset lug image. For example, the preset lug image is a standard lug image for a specific cell type.

The optimization algorithm in each step of FIG. 5 will be explained in further detail below. First, for example, if part or all of the target lug image (for example, an image after denoising processing and grayscale processing) is not detected in the first detection area S′, the final grayscale image Gray(i,j) can be first performed binary separation of pixels through the following formula:

$$B ( i , j ) = \{ \begin{matrix}0 & Gray ( i , j ) <= h \\ 1 & Gray ( i , j ) > h\end{matrix}$$

wherein, the h value is the judgment threshold through adjustment and test, and the value range of the h value is 125˜255. The h value is adjustable in the range of 125˜255 according to the detection situation, for example, the specific h value can be tested through on-site histogram adjustment, and after grayscale processing, the value at each Gray(i,j) position of the image is between (0-255). Binary separation of the final grayscale image can make the image only appear in black and white colors.

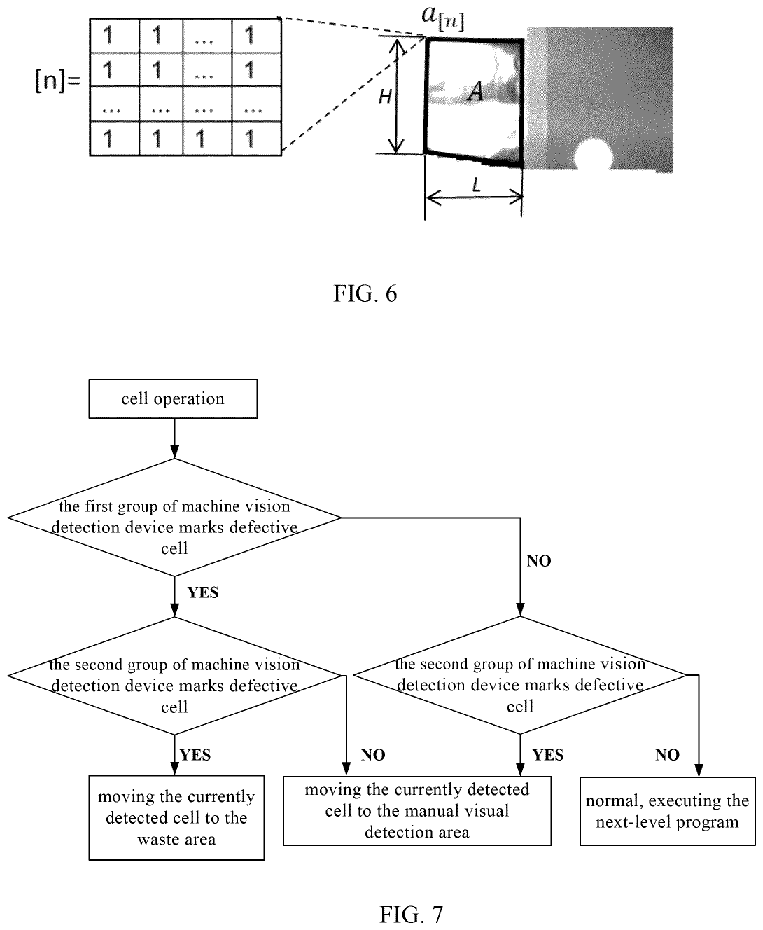

For example, referring to FIG. 6, after binary separation of the final grayscale image, the target lug image can be obtained in the second detection area S through a regional consistency algorithm. The regional consistency algorithm can process images through the following formula:

$${a}_{[ n ]}^{′} = \{ \begin{matrix}255 & area {a}_{[ n ]} = [ n ] \\ 0 & others\end{matrix}$$

First, constructing a square matrix [n] with nth order all being 1, and obtaining a same area pixel a_{[n]} in the second detection area, wherein, the same area pixel a_{[n]} is obtained by binary separation of the final grayscale image obtained by denoising process and grayscale process in the second detection area. Comparing the same area pixel a_{[n]} with the square matrix [n], and if the result shows consistency, assigning the position where the same area pixel a_{[n]} is located to a value of 255 and set it as an area point; and connecting all the area points in the second detection area to form the closed region A, and obtaining the outline, length and width dimensions or area of the target lug image a′_{[n]} according to the closed region A, thereby determining whether the currently detected cell is a defective cell.

Continuing to refer to FIG. 5, the detection method has a preset lug image with a normal lug image that is set in advance. The detection method 10 determines whether the current detection cell is a defective cell based on the outline of the target lug image in the second detection area S by comparing the similarity SIM (i,j) between area A and the preset lug image. In some preferred embodiments of this disclosure, the specific formula for determining similarity is as follows:

$$SIM ( i , j ) = \frac{u * \sum A ( i , j ) Y ( i , j )}{\sqrt{\sum {( A ( i , j ) )}^{2}} \sqrt{\sum {( Y ( i , j ) )}^{2}}}$$

wherein, A(i,j) is an outer edge of the region A, Y(i,j) is the outer edge of the preset lug image, and u is an adjustable scaling coefficient which can be set manually during the initial comparison of the vision software of the machine vision detection device.

Further, if the outline of the target tab image matches the preset tab image, the length and width dimensions of the target tab image are further calculated. If the outline of the target tab image does not match the preset tab image, then mark the lug as shape defect.

For example, if the outline of the target lug image matches the preset lug image, the length and width dimensions of the target lug image need to be further calculated. Calculating the length and width dimensions of the target lug image mainly includes calculating a lug transverse width L and a lug longitudinal width H, then determining whether the currently detected cell is defective cell according to the length and width dimensions of the target lug image in the second detection area, and the calculation formula of L and H are as below:

$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix}$$

wherein, a′_{[n]}_{_{tw}} is a lateral position value of pixel a′_{[n]} in column w and row i, a′_{[n]}_{ᵢᵥ} is a horizontal position value of pixel a′_{[n]} in column v and row i, a′_{[n]}_{ₚⱼ} is a vertical position value of pixel a′_{[n]} in column j and row p, a′_{[n]}_{_{qj}} is a vertical position value of pixel a′_{[n]} in column j and row q, and the w, v, p and q are determined after the area A, i.e. the positions corresponding to the four vertices of the area A automatically obtained in the image with the area A.

Further, if the length and width dimensions of the target lug image match the preset lug image, then the area of the target lug image is further calculated, and if the length and width dimensions of the target lug image do not match the preset lug image, then mark the lug as shape defect.

Continuing to refer to FIG. 5, if the outline and length and width dimensions of the target lug image match the preset lug image, it continues to calculate the area of the target lug image, that is calculating the area S_{A} of the region A, then determining whether the currently detected cell is defective cell according to the area of the target lug image in the second detection area:

$${s}_{A} = \frac{{\int }_{{L}_{w}}^{{L}_{v}} f ( {a}_{[ n ]}^{′} ) dL + {\int }_{{H}_{p}}^{{H}_{q}} g ( {a}_{[ n ]}^{′} ) dH}{2}$$

wherein, L_{w} is the left starting point of the lug transverse width L, Lᵥ is the right end point of the lug transverse width L, Hₚ is the lower starting point of the lug longitudinal width H, H_{q} is the upper end point of the lug longitudinal width H, f(a′_{[n]}) is the function value of the transverse synthesis of the lug, g(a′_{[n]}) is the function value of the longitudinal synthesis of the lug.

Further, if the area of the target lug image matches the preset lug image, the lug is judged to be a normal lug, which means it can run normally and the next-level program is executed, and if the outline of the target lug image does not match the preset lug image, marking the lug as a size defect.

It can be understood that a preferred embodiment of the detection method 10 shown in FIG. 1a and the detection method 100 shown in FIG. 1b has been described in detail with reference to FIG. 5 and FIG. 6. However, this disclosure is not limited to the content described above. For example, referring to FIG. 5, when it is necessary to determine the outline, length and width dimensions and area of the lug in the second detection area S2, one or more of the judgment dimensions can be selected for measurement, such as judging the outline alone, judging the length and width dimensions alone, judging area alone or a combination of the above two or three dimensions, and when a combination of two or three judgment dimensions is used, different judgment dimensions can be applied at the same time, or different judgment dimensions can be applied sequentially. Specifically, the order of judging the outline, judging the length and width, and judging the area can also be adjusted based on the specific order in actual situation. Of course, in this embodiment, the outline, length and width dimensions, and area are judged in order, but in practical applications, since the algorithm of outline, length and width dimensions is simpler than the algorithm of area, it is preferable to first judge the outline and the length and width dimensions. On the basis of its qualified judgment, the reliability of the judgment is further improved by judging the area, so that the defective lug can be detected more quickly and accurately, the judging speed is faster, and the effect is better.

Further, referring to FIG. 7, FIG. 7 further optimizes the detection method 10 shown in FIG. 1a and the detection method 100 shown in FIG. 1b, and the optimized detection method can also refer to the detection system shown in FIG. 3, that is, combined with the detection system 30 shown in FIG. 3 to obtain an optimized detection method for lug defects as shown in FIG. 7. In this embodiment, during the operation of the cell, if the first group of machine vision detection device 31 located at the first detection position does not mark the currently detected cell as a defective cell, the second group machine vision detection device 31′ located at the second detection position will continue to determine whether the currently detected cell is a defective cell. If the second group of machine visual detection device 31′ does not determine the current detected cell is a defective cell, the cell is normal and next-level program is executed, such as hot pressing of normal cells; if the second group of visual detection device 31′ determines the current cell is a defective cell, the current detected cell will be judged to be a suspected defective cell, and the current detected cell can be moved to the manual visual detection area to wait for manual review. In this embodiment, in order to keep the production process smooth, both normal lugs and defective lugs will be prepared into finished cell according to the normal process, however, during the preparation process of the cell, the machine vision detection device will mark the detected cells with defective lugs to facilitate re-detection of defective cells or suspected defective cells in the subsequent process to better ensure the quality of the cell.

Further, if the first group of machine vision detection device 31 located at the first detection position marks the current detected cell as a defective cell and transmits the result to the second group of vision detection device 31′, then through the second group of machine vision detection device 31 located at the second detection position it determines whether the currently detected cell is a defective cell. If the second group of vision detection device 31′ determines that the currently detected cell is not a defective cell, it will determine the currently detected cell as a suspected defective cell, and run the currently detected cell to the manual visual detection area to wait for manual review; if the second group of vision detection device 31′ determines that the currently detected cell is a defective cell, it then moves the currently detected cell to the waste area. In other embodiments, if the second group of machine vision detection device 31′ determines that the currently detected cell is not a defective cell, the second group of machine vision detection device 31′ can also transmit the judgment result to the first group of machine vision detection device 31, and the first group of machine vision detection device 31 determines that the currently detected cell is a suspected defective cell, and moves the currently detected cell to the manual visual detection area.

The basic concepts have been described above, obviously, for those skilled in the art, the above disclosure of the disclosure is only an example and does not constitute a limitation to the present disclosure. Although not expressly stated here, various modifications, improvements and amendments to this disclosure may be made by those skilled in the art. Such modifications, improvements, and amendments are suggested in this disclosure, so such modifications, improvements, and amendments still belong to the spirit and scope of the exemplary embodiments of this disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that two or more references to “one embodiment” or “an embodiment” or “an alternative embodiment” in different places in this specification do not necessarily refer to the same embodiment. In addition, certain features, structures, or characteristics of one or more embodiments of the present disclosure may be properly combined.

Some aspects of the present disclosure may be entirely implemented by hardware, may be entirely implemented by software (including firmware, resident software, microcode, etc.), or may be implemented by a combination of hardware and software. The above hardware or software may be referred to as “block”, “module”, “engine”, “unit”, “component” or “system”. The processor can be one or more Application Specific Integrated Circuits (ASIC), Digital Signal Processors (DSPs), Digital Signal Processing Devices (DAPDs), Programmable Logic Devices (PLDs), Field Programmable Gate Arrays (FPGAs), a processor, a controller, a microcontroller, a microprocessor, or a combination thereof. Additionally, aspects of the present disclosure may be embodied as a computer product comprising computer readable program code on one or more computer readable media. For example, computer-readable media may include, but are not limited to, magnetic storage devices (e.g., hard disks, floppy disks, magnetic tape . . . ), optical disks (e.g., compact disk CDs, digital versatile disks DVD . . . ), smart cards, and flash memory devices (e.g., cards, sticks, key drives . . . ).

A computer readable medium may contain a propagated data signal embodying a computer program code, for example, in baseband or as part of a carrier wave. The propagated signal may take many forms, including electromagnetic, optical, etc., or a suitable combination. The computer readable medium can be any computer readable medium other than computer readable storage medium, which can communicate, propagate, or transfer the program for use by being connected to an instruction execution system, apparatus, or device. Program code on a computer readable medium may be transmitted over any suitable medium, including radio, electrical cables, fiber optic cables, radio frequency signals, or the like, or combinations of any of the foregoing.

In the same way, it should be noted that in order to simplify the expression disclosed in the present disclosure and help the understanding of one or more embodiments of the disclosure, in the foregoing description of the embodiments of the present disclosure, sometimes multiple features are combined into one embodiment, drawings or descriptions thereof. However, this method of disclosure does not imply that the subject matter of the disclosure requires more features than are recited in the claims. Indeed, embodiment features are less than all features of a single foregoing disclosed embodiment.

In some embodiments, numbers describing the quantity of components and attributes are used, it should be understood that such numbers used in the description of the embodiments use the modifiers “about”, “approximately” or “substantially” in some examples. Unless otherwise stated, “about”, “approximately” or “substantially” indicates that the stated figure allows for a variation of +20%. Accordingly, in some embodiments, the numerical parameters used in the specification and claims are approximations that can vary depending upon the desired characteristics of individual embodiments. In some embodiments, numerical parameters should take into account the specified significant digits and adopt the general digit reservation method. Although the numerical ranges and parameters used in some embodiments of the present disclosure to confirm the breadth of the scope are approximate values, in specific embodiments, such numerical values are set as precisely as practicable.

Although the present disclosure has been described with reference to the current specific embodiments, those of ordinary skill in the art should recognize that the above embodiments are only used to illustrate the present disclosure, and various equivalent changes or substitutions can also be made without departing from the spirit of the present disclosure, therefore, as long as the changes and modifications to the above-mentioned embodiments are within the spirit of the present disclosure, they will all fall within the scope of the claims of the present disclosure.

1. A lug defect detection method, comprising:
during a preparation process of a battery cell, collecting original image of a relevant area of lug, wherein, the battery cell includes a pole piece, and the pole piece includes a pole piece body and a lug;
in a digitally processed original image, setting a baseline based on an edge position of the pole piece body, and from the baseline, setting a side close to the pole piece body as a first detection area, setting another side away from the pole piece body as a second detection area; and
detecting a target lug image in the first detection region and the second detection region according to a preset sequence and determining whether a currently detected cell is a defective cell.

2. The detection method according to claim 1, wherein during a preparation process of a battery cell, step of collecting original image of a relevant area of lug further comprises: during a process of continuous preparation of multiple battery cells, continuously collecting original image of a relevant area of lug corresponding to each battery cell before the pole piece corresponding to each battery cell is rolled or stacked.

3. The detection method according to claim 2, further comprising using two sets of machine vision inspection devices to respectively perform the step of collecting original image, setting the baseline and determining whether the currently detected cell is the defective cell, the two sets of machine vision inspection devices are respectively arranged in a first detection position and a second detection position during the preparation process of the battery cell, and the detection method further includes:
when both sets of machine vision inspection devices determine that the currently detected cell is a defective cell, marking the currently detected cell as a defective cell; and
when only one set of machine vision inspection devices determines the currently detected cell is a defective cell, marking the currently detected cell as a suspected defective cell for re-inspection.

4. The detection method according to claim 1, wherein the preset sequence includes sequentially detecting the first detection region and the second detection area, wherein if part or all of the target lug image is detected in the first detection area, judging the currently detected cell as a defective cell, otherwise, determining whether the currently detected cell is a defective cell according to one of or a combination of one or more of outline, length and width dimensions or area of the target lug image in the second detection area.

5. The detection method according to claim 4, wherein if part or all of the target lug image is not detected in the first detection area, the detection method further includes using a regional consistency algorithm to obtain multiple area points in the second detection area, connecting multiple area points to form a closed area, thereby obtaining the target lug image, wherein, the regional consistency algorithm includes:
constructing a square matrix [n] with nth order all being 1, and obtain a same area pixel a_{[n]} in the second detection area, wherein, the same area pixel a_{[n]} is obtained by binary separation of a final grayscale image obtained by denoising process and grayscale process in the second detection area;
comparing the same area pixel a_{[n]} with the square matrix [n], and if a result shows consistency, assigning a position where the same area pixel a_{[n]} is located to a value of 255 and setting as an area point; and
connecting all area points in the second detection area to form the closed region A, and obtaining the outline, length and width dimensions or area of the target lug image a′_{[n]} according to the closed region A, thereby determining whether the currently detected cell is a defective cell.

6. The detection method according to claim 5, further comprising: using following method to compare a similarity SIM(i,j) between the region A and a preset lug image, thereby determining whether the currently detected cell is defective cell according to an outline of the target lug image in the second detection area:
$$SIM ( i , j ) = \frac{u * \sum A ( i , j ) Y ( i , j )}{\sqrt{\sum {( A ( i , j ) )}^{2}} \sqrt{\sum {( Y ( i , j ) )}^{2}}}$$
wherein, A(i,j) is an outer edge of the region A, Y(i,j) is an outer edge of the preset lug image, and u is an adjustable scaling coefficient.

7. The detection method according to claim 5, further comprising: using following manner to calculate a lug transverse width L and a lug longitudinal width H, thereby determining whether the currently detected cell is defective cell according to the length and width dimensions of the target lug image in the second detection area:
$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix}$$
wherein, a′_{[n]}_{_{iw}} is a lateral position value of pixel a′_{[n]} in column w and row i, a′_{[n]}_{ᵢᵥ} is a horizontal position value of pixel a′_{[n]} in column v and row i, a′_{[n]}, is a vertical position value of pixel a′_{[n]} in column j and row p, a′_{[n]}_{_{qj}}, is a vertical position value of pixel a′_{[n]} in column j and row q, and the w, v, p and q are obtained according to the region A, N represents a number of rows of a′_{[n]}, and M represents a number of columns of a′_{[n]}.

8. The detection method according to claim 5, further comprising: using following manner to calculate a lug transverse width L and a lug longitudinal width H, then calculating an area S_{A} of the region A, then determining whether the currently detected cell is defective cell according to an area of the target lug image in the second detection area:
$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix} \\ {s}_{A} = \frac{{\int }_{{L}_{w}}^{{L}_{v}} f ( {a}_{[ n ]}^{′} ) dL + {\int }_{{H}_{p}}^{{H}_{q}} g ( {a}_{[ n ]}^{′} ) dH}{2}$$
wherein, a′_{[n]}_{_{tw}} is a lateral position value of pixel a′_{[n]} in column w and row i, a′_{[n]}_{ᵢᵥ} is a horizontal position value of pixel a′_{[n]} in column v and row i, a′_{[n]}_{ₚⱼ} is the vertical position value of pixel a′_{[n]} in column j and row p, a′_{[n]}_{_{qj}} is the vertical position value of pixel a′_{[n]} in column j and row q, and the w, v, p and q are obtained according to the region A; L_{w} is a left starting point of the lug transverse width L, Lᵥ is a right end point of the lug transverse width L, Hₚ is a lower starting point of the lug longitudinal width H, H_{q} is an upper end point of the lug longitudinal width H, f(a′_{[n]}) is a function value of the transverse synthesis of the lug, g(a′_{[n]}) is a function value of the longitudinal synthesis of the lug, N represents a number of rows of a′_{[n]}, and M represents a number of columns of a′_{[n]}.

9. The detection method according to claim 1, wherein the digitally processed original image is a final grayscale image Gray(i,j) obtained by sequentially performing the denoising process and the grayscale process on the original image, and the method further includes setting the baseline in the final grayscale image Gray(i,j) according to an edge position of the pole piece body of the battery cell.

10. The detection method according to claim 9, wherein if part or all of the target lug image is not detected in the first detection area, the detection method further includes performing a binary separation of pixel on the final grayscale image Gray(i,j) according to following formula:
$$B ( i , j ) = \{ \begin{matrix}0 & Gray ( i , j ) <= h \\ 1 & Gray ( i , j ) > h\end{matrix}$$
wherein, a value range of h is 125˜255.

11. The detection method according to claim 9, wherein the denoising process comprises realizing stacking of three primary colors in the following manner to obtain the denoised image corresponding to the original image:
$$\{ \begin{matrix}R ( i , j ) = {\sum }_{m , n} R ( i + m , j + n ) * {K}_{R} ( m , n ) \\ G ( i , j ) = {\sum }_{m , n} G ( i + m , j + n ) * {K}_{G} ( m , n ) \\ B ( i , j ) = {\sum }_{m , n} B ( i + m , j + n ) * {K}_{B} ( m , n )\end{matrix}$$
wherein, (i,j) is a two-dimensional matrix position of any pixel in the original image, R(i,j), G(i,j) and B(i,j) are corresponding values of the three primary colors RGB, K_{R}(m,n), K_{G}(m,n) and K_{B}(m,n) are filter algorithms corresponding to the three primary colors RGB.

12. The detection method according to claim 11, wherein the grayscale process comprises processing the denoised image in following manner to obtain the final grayscale image Gray(i,j):
$$Gray ( i , j ) = {k}_{1} R ( i , j ) + {k}_{2} G ( i , j ) + {k}_{3} B ( i , j )$$
wherein, k₁, k₂ and k₃ are corresponding weighted values of the three primary colors RGB.

13. A lug defect detection system, comprising: at least one set of machine vision inspection device, the machine vision inspection device includes a camera and a processor, wherein,
the camera is adapted to collect original image of relevant area of lug during a preparation process of a battery cell, wherein the battery cell includes a pole piece, and the pole piece includes a pole piece body and a lug;
the processor is adapted to digitally process the original image and set a baseline according to an edge position of the pole piece body of the battery cell, wherein, from the baseline, a side close to the pole piece body in the battery cell is a first detection area, and another side away from the pole piece body is a second detection area; and
the processor is also adapted to detect a target lug image in the first detection area and the second detection area in a preset sequence according to the detection method in claim 1 and determine whether the currently detected cell is a defective cell.

14. The detection system according to claim 13, wherein number of the machine vision inspection devices is two groups, comprising a first group of machine vision inspection devices located at a first detection position and a second group of machine vision inspection devices located at a second detection position, the first detection position and the second detection positions are respectively located at process positions before the pole piece are rolled or stacked during the preparation process of the battery cell, and the first detection position is located in a former production sequence compared to the second detection position, wherein,
when both the first group of machine vision inspection devices and the second group of machine vision inspection devices determine that the currently detected cell is a defective cell, the first group of machine vision inspection device and/or the second group of machine vision inspection device is configured to mark the currently detected cell as a defective cell; and
when only the first group of machine vision inspection device or only the second group of machine vision inspection device determine that the currently detected cell is a defective cell, the first group of machine vision inspection device or the second group of machine vision inspection device is configured to mark the currently detected cell as a suspected defective cell for re-inspection.

15. The detection system according to claim 13, wherein the preset sequence includes sequentially detecting the first detection region and the second detection area, and the processor is configured as: if part or all of the target lug image is detected in the first detection area, judging the currently detected cell as a defective cell, otherwise, determining whether the currently detected cell is a defective cell according to one of or a combination of one or more of outline, length and width dimensions or area of the target lug image in the second detection area.

16. The detection system according to claim 15, wherein the processor is configured as: if part or all of the target lug image is not detected in the first detection area, the detection method further includes using a regional consistency algorithm to obtain multiple area points in the second detection area, connecting multiple area points to form a closed area, thereby obtaining the target lug image, wherein, the regional consistency algorithm includes:
constructing a square matrix [n] with nth order all being 1, and obtain a same area pixel a_{[n]} in the second detection area, wherein, the same area pixel a_{[n]} is obtained by binary separation of a final grayscale image obtained by denoising process and grayscale process in the second detection area;
comparing the same area pixel a_{[n]} with the square matrix [n], and if a result shows consistency, assigning a position where the same area pixel a_{[n]} is located to a value of 255 and setting as an area point; and
connecting all area points in the second detection area to form the closed region A, and obtaining the outline, length and width dimensions or area of the target lug image a′_{[n]} according to the closed region A, thereby determining whether the currently detected cell is a defective cell.

17. The detection system according to claim 16, wherein the processor is configured as: using following method to compare a similarity SIM(i,j) between the region A and a preset lug image, thereby determining whether the currently detected cell is defective cell according to an outline of the target lug image in the second detection area:
$$SIM ( i , j ) = \frac{u * \sum A ( i , j ) Y ( i , j )}{\sqrt{\sum {( A ( i , j ) )}^{2}} \sqrt{\sum {( Y ( i , j ) )}^{2}}}$$
wherein, A(i,j) is an outer edge of the region A, Y(i,j) is an outer edge of the preset lug image, and u is an adjustable scaling coefficient.

18. The detection system according to claim 16, wherein the processor is configured as: using following manner to calculate a lug transverse width L and a lug longitudinal width H, thereby determining whether the currently detected cell is defective cell according to the length and width dimensions of the target lug image in the second detection area:
$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix}$$
wherein, a′_{[n]}_{_{tw}} is a lateral position value of pixel a′_{[n]} in column w and row i, a′_{[n]}_{ᵢᵥ} is a horizontal position value of pixel a′_{[n]} in column v and row i, a′_{[n]}_{ₚⱼ} is a vertical position value of pixel a′_{[n]} in column j and row p, a′_{[n]}_{_{qj}} is a vertical position value of pixel a′_{[n]} in column j and row q, and the w, v, p and q are obtained according to the region A, N represents a number of rows of a′_{[n]}, and M represents a number of columns of a′_{[n]}.

19. The detection system according to claim 16, wherein the processor is configured as: using following manner to calculate a lug transverse width L and a lug longitudinal width H, then calculating an area S_{A} of the region A, then determining whether the currently detected cell is defective cell according to an area of the target lug image in the second detection area:
$$\{ \begin{matrix}L = \frac{{\sum }_{i = 1}^{N} {a}_{{[ n ]}_{iw}}^{′}}{N} - \frac{{\sum }_{i = 1}^{N} {a}_{{[ n ]}_{iv}}^{′}}{N} \\ H = \frac{{\sum }_{j = 1}^{M} {a}_{{[ n ]}_{pj}}^{′}}{M} - \frac{{\sum }_{j = 1}^{M} {a}_{{[ n ]}_{qj}}^{′}}{M}\end{matrix} \\ {s}_{A} = \frac{{\int }_{{L}_{w}}^{{L}_{v}} f ( {a}_{[ n ]}^{′} ) dL + {\int }_{{H}_{p}}^{{H}_{q}} g ( {a}_{[ n ]}^{′} ) dH}{2}$$
wherein, a′_{[n]}_{_{iw}} is a lateral position value of pixel a′_{[n]} in column w and row i, a′_{[n]}_{ᵢᵥ} is a horizontal position value of pixel a′_{[n]} in column v and row i, a′_{[n]}_{ₚⱼ} is the vertical position value of pixel a′_{[n]} in column j and row p, a′_{[n]}_{_{qj}} is the vertical position value of pixel a′_{[n]} in column j and row q, and the w, v, p and q are obtained according to the region A; L_{w} is a left starting point of the lug transverse width L, Lᵥ is a right end point of the lug transverse width L, Hₚ is a lower starting point of the lug longitudinal width H, H_{q} is an upper end point of the lug longitudinal width H, f(a′_{[n]}) is a function value of the transverse synthesis of the lug, g(a′_{[n]}) is a function value of the longitudinal synthesis of the lug, N represents a number of rows of a′_{[n]}, and M represents a number of columns of a′_{[n]}.

20. The detection method according to claim 13, wherein the digitally processed original image is a final grayscale image Gray(i,j) obtained by sequentially performing the denoising process and the grayscale process on the original image, and the method further includes setting the baseline in the final grayscale image Gray(i,j) according to an edge position of the pole piece body of the battery cell.
